(19) United States
(12) Patent Application Publication
(10) Pub. No.: US 2026/0319881 A1
(43) Pub. Date: Oct. 15, 2026

(54) SYSTEM AND METHOD OF PROVIDING INITIAL POWER TO AN INFORMATION HANDLING SYSTEM

(71) Applicant: DELL PRODUCTS L.P., Round Rock, TX (US)

(72) Inventors: Amrita Sidhu Maguire, Cedar Park, TX (US); Timothy M. Lambert, Austin, TX (US); Eduardo Escamilla, Round Rock, TX (US)

(21) Appl. No.: 19/179,067

(22) Filed: Apr. 15, 2025

(51) Int. Cl. G06F 11/07

(52) U.S. Cl. CPC G06F 11/0793; G06F 11/0748

(57) ABSTRACT

An information handling system includes a cooling plate and a wet/dry leak diagnostic circuit. The wet/dry leak diagnostic circuit includes a leak sensor adjacent the cooling plate and a microprocessor operably coupled to the leak sensor. The microprocessor to detect when power is supplied to the leak sensor, initiate a wet/dry diagnostic test, and selectively provide initial power to the information handling system based on a result of the wet/dry diagnostic test.

### FIELD OF THE DISCLOSURE

The present disclosure generally relates to information handling systems, and more particularly relates to providing initial power to information handling systems.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes a cooling plate and a wet/dry leak diagnostic circuit. The wet/dry leak diagnostic circuit includes a leak sensor adjacent the cooling plate and a microprocessor operably coupled to the leak sensor. The microprocessor to detect when power is supplied to the leak sensor, initiate a wet/dry diagnostic test, and selectively provide initial power to the information handling system based on a result of the wet/dry diagnostic test.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system according to an embodiment of the present disclosure;

FIG. 2 is a block diagram of an information handling system according to an embodiment of the present disclosure;

FIG. 3 is a block diagram of a wet/dry test circuit for an information handling system according to an embodiment of the disclosure;

FIGS. 4 and 5 are a flow chart of a method of providing initial power to an information handling system according to an embodiment; and

The use of the same reference symbols in different drawings indicates similar or identical items.

### DETAILED DESCRIPTION OF THE DRAWINGS

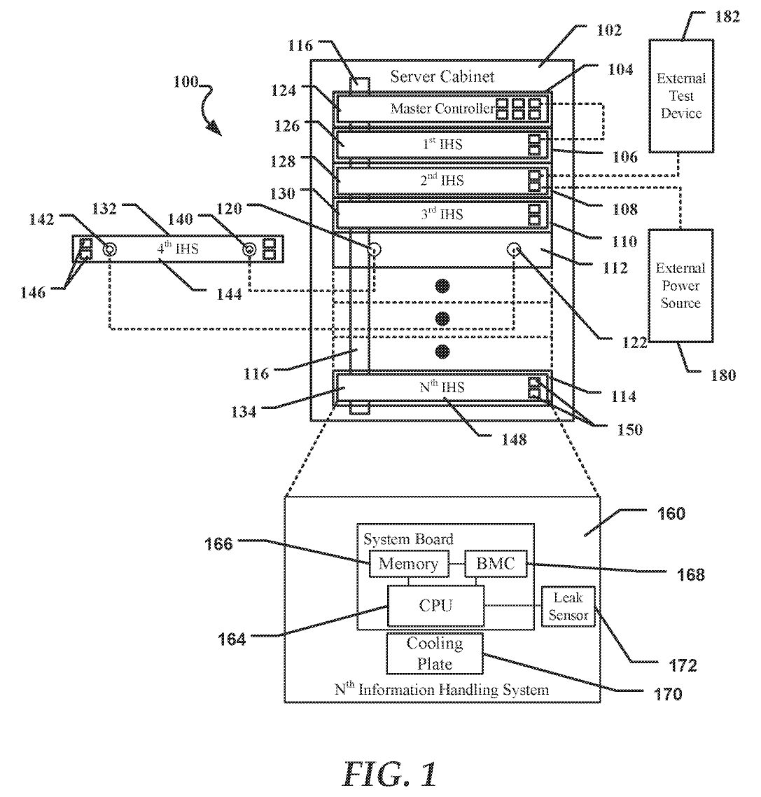

Referring initially to FIG. 1, a system is illustrated and generally designated 100. As shown, the system 100 includes a cabinet 102 (aka, a rack) having a primary device shelf 104, a first secondary device shelf 106, a second secondary device shelf 108, a third secondary device shelf 110, a fourth secondary device shelf 112, and an Nth secondary device shelf 114. A bus bar 116 spans the device shelves 104 – 114 and provides power to devices disposed, or otherwise installed, in the device shelves 104 – 114. Further, each secondary device shelf 106 – 114 includes a first inlet valve portion 120 and a first outlet valve portion 122.

As shown, the system 100 includes a master controller 124 that is disposed or otherwise installed in the primary device shelf 104. Moreover, the system 100 includes a first information handling system 126 that is disposed or otherwise installed in the first secondary device shelf 106, a second information handling system 128 that is disposed or otherwise installed in the second secondary device shelf 108, a third information handling system 130 that is disposed or otherwise installed in the third secondary device shelf 110, a fourth information handling system 132 that is disposed or otherwise installed in the fourth secondary device shelf 112, and an Nth information handling system 134 that is disposed or otherwise installed in the Nth secondary device shelf 114. The master controller 124 may be operably connected to each of the information handling systems 126 – 134 in order to activate a wet/dry diagnostic test circuit embedded within each of the information handling systems 126 – 134 to determine whether any of the information handling systems 126 – 134 are experiencing cooling fluid leaks prior to the initial power on of each information handling systems 126 – 134. If a fluid leak is detected in any of the information handling systems 126 – 134, all of the information handling systems 126 – 134 are maintained in a de-energized state until the leak is remediated, e.g., by identifying and fixing the leak or by replacing the specific information handling system with the leak.

For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Each information handling system 124 – 134 is substantially identical and may include a second inlet valve portion 140 and a second outlet valve portion 142 extending from a rear panel 144. The second inlet valve portion 140 on each information handling system 124 – 134 engages with and connects to the first inlet valve portion 120 in a respective secondary device shelf 104 – 114 to create a fluid inlet valve that provides cooling fluid to an information handling system 124 – 134. The second outlet valve portion 142 on each information handling system 124 – 134 engages with and connects to the first outlet valve portion 122 in a respective secondary device shelf 104 – 114 to create a fluid inlet valve that provides cooling fluid to an information handling system 124 – 134. The rear panel 144 of each information handling system 124 – 134 may further include one or more electrical connectors 146. Moreover, the front panel 148 of each information handling system 124 – 134 may also include one or more electrical connectors 150. The electrical connectors 146, 150 may include power connectors, USB ports, SATA connectors, some other connectors, or any combination thereof.

As further shown, in general, each information handling system 124 – 134 may include a system board 160, or motherboard, that may have several electronic components disposed thereon or coupled thereto. For example, the system board 160 may include a central processing unit (CPU) 164 installed, or otherwise disposed, thereon. The information handling system 104 may also include a memory 166 coupled to the CPU 164. Moreover, a baseboard management controller 168 may be disposed on the system board 160 and may be coupled to the CPU 164 and the memory 166. Other components necessary to the operation of the information handling system 124 – 134, and well known in the art, may be disposed on the system board 160.

A cooling plate 170 may be adjacent the system board 160. Specifically, the cooling plate 170 is adjacent the CPU 164 which may generate and emit a substantial amount of heat during operation of the information handling system 124 – 134. A cooling distribution unit may be connected to the cooling plate 170. During operation, the cooling distribution unit may circulate coolant to the cooling plate 170 in order to lower the temperature of the cooling plate 170 and therefore, transfer heat generated by the CPU 164 away from the CPU 164, and the system board 160, in order to lower the operating temperature of the CPU 164, the system board 160, and the other components disposed on the system board 160. Each information handling system 124 – 134 may also include an optical leak sensor 172 configured to detect any fluid leaks within the information handling system 124 – 134.

FIG. 1 further shows that an external power source 180 may be connected to each information handling system 124 – 134. The external power source 180 may be a mobile power bank that is connected to a USB port on the front of each information handling system 124 – 134 prior to the initial power on of each information handling system 124 – 134 in order to provide power to an internal wet/dry test circuit, described below, within each information handling system 124 – 134. Alternatively, an external test device 182 may be connected to each information handling system 124 – 134. The external test device 182 may include power and test circuitry configured to provide power to the internal wet/dry test circuit within each information handling system 124 – 134 and to activate the wet/dry test circuit in order to determine whether any of the information handling systems 124 – 134 are experiencing fluid leaks prior to the initial power on of each information handling system 124 – 134.

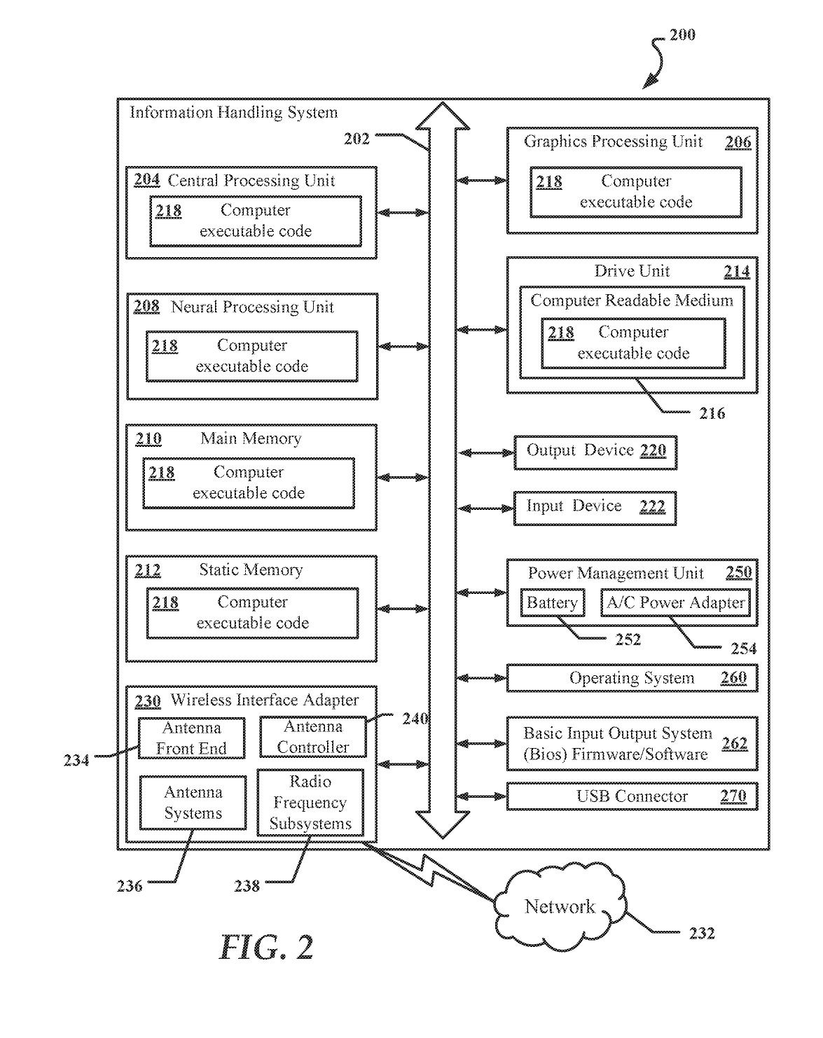

FIG. 2 illustrates an information handling system 200 having various components disposed therein. For purposes of this disclosure, the information handling system 200 may include any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, the information handling system 200 can be a personal computer, a mobile device (e.g., a personal digital assistant (PDA) or a smart phone), server (e.g., a blade server or a rack server), a consumer electronic information handling system, a network server or storage device, a network router, switch, or bridge, wireless router, or other network communication information handling system, a network connected device (cellular telephone, tablet information handling system, etc.), IoT computing device, wearable computing device (e.g., a smart watch or smart glasses), a set-top box (STB), a mobile device, a palmtop computer, a laptop computer, a desktop computer, a communications device, an access point (AP), a base station transceiver, a wireless telephone, a land-line telephone, a control system, a camera, a scanner, a facsimile machine, a printer, a pager, a personal device, a web appliance, or any other suitable machine capable of executing a set of instructions (sequential or otherwise) that specify actions to be taken by that machine, and can vary in size, shape, performance, price, and functionality.

In a networked deployment, for example, the information handling system 200 may operate in the capacity of a server or as a client computer in a server-client network environment, or as a peer computer system in a peer-to-peer (or distributed) network environment, or as a master controller as illustrated in FIG. 1. In a particular embodiment, the information handling system 200 can be implemented using electronic information handling systems that provide voice, video or data communication. For example, an information handling system 200 may be any mobile or other computing device capable of executing a set of instructions (sequential or otherwise) that specify actions to be taken by that machine. Further, while a single information handling system 200 is illustrated, the term “system” shall also be taken to include any collection of systems or sub-systems that individually or jointly execute a set, or multiple sets, of instructions to perform one or more computer functions.

In general, the information handling system 200 can include memory (volatile (e.g., random-access memory, etc.), nonvolatile (read-only memory, flash memory etc.) or any combination thereof), one or more processing resources, such as a central processing unit (CPU), a graphics processing unit (GPU), a neural processing unit (NPU), hardware or software control logic, or any combination thereof. Additional components of the information handling system 200 can include one or more storage devices, one or more communications ports for communicating with external devices, as well as, various input and output (I/O) devices, such as a keyboard, a mouse, a video/graphic display, or any combination thereof. The information handling system 200 can also include one or more buses operable to transmit communications between the various hardware components. Portions of an information handling system 200 may themselves be considered information handling systems 200. The information handling system 200 can include devices or modules that embody one or more of the devices or execute instructions for the one or more systems and modules described herein, and operates to perform one or more of the methods described herein.

As illustrated in FIG. 2, in particular, the information handling system 200 can include one or more buses 202 operable to transmit communications between the various hardware components such as any combination of various input and output (I/O) devices described herein. The information handling system 200 can include one or more processors operably coupled to the bus 202. For example, the information handling system 200 can include a central processing unit (CPU) 204, a graphics processing unit (GPU) 206, a neural processing unit (NPU) 208, or any combination thereof. The CPU 204, the GPU 206, and the NPU 208 may include control logic and may individually, or collectively, operate to execute code that is either firmware or software code. Moreover, the information handling system 200 can include one or more memory devices such as a main memory 210, a static memory 212, and a drive unit 214 having a computer readable medium 216 disposed therein. The drive unit 214 can include a hard drive unit, a solid state drive unit, or a combination thereof. Further, the various memory devices 210, 212, 214, 216 may include volatile memory (e.g., random-access memory, etc.), nonvolatile memory (read-only memory, flash memory etc.) or any combination thereof).

The information handling system 200 includes computer executable code 218 that may reside on, or be executed by, the CPU 204, the GPU 206, the NPU 208, the main memory 210, the static memory 212, the computer readable medium 216 of the drive unit 214, or any combination thereof. The computer executable code 218 can include instructions (e.g., software algorithms), parameters, and profiles. The computer executable code 218 that may operate on servers or systems, remote data centers, or on-box in individual client information handling systems according to various embodiments herein. In some embodiments, it is understood any or all portions of the computer executable code 218 may operate on, or be executed by, the CPU 204, the GPU 206, the NPU 208, the main memory 210, the static memory 212, the computer readable medium 216 of the drive unit 214, or any combination thereof. In some embodiments, it is understood any or all portions of computer executable code 218 may operate on a plurality of information handling systems 200.

As shown, the information handling system 200 may further include an output device 220, e.g., a video display output. In an embodiment, the output device 220 may include a liquid crystal display (LCD), an organic light emitting diode (OLED), a flat panel display, a solid-state display, a curved panel display, a flexible panel display, or a combination thereof. Further, the output device 220 may include one or more sound output devices, e.g., speakers. As further illustrated, the information handling system 200 may include an input device 222 that may include an alpha numeric input device, such as a keyboard, and/or a cursor control device, such as a mouse, touchpad, or gesture or touch screen input device.

The information handling system 200 may also include a network interface device, shown as a wireless interface adapter 230, that can provide connectivity to a network 232, e.g., a wide area network (WAN), a local area network (LAN), wireless local area network (WLAN), a wireless personal area network (WPAN), a wireless wide area network (WWAN), or another network. In an embodiment, the WAN, WWAN, LAN, and WLAN may each include an access point used to operatively coupled the information handling system 200 to a network. In a specific embodiment, the network 254 may include macro-cellular connections via one or more base stations, one or more wireless access points (e.g., Wi-Fi or WiGig), one or more licensed or unlicensed WWAN small cell base stations, or a combination thereof. Further, network connectivity may be a wired or wireless connection.

As depicted, the wireless interface adapter 230 may include an antenna front end 234, one or more antenna systems 236, one or more radio frequency subsystems 238, and an antenna controller 240. These components may include transmitter/receiver circuitry, modem circuitry, one or more radio frequency front end circuits, one or more wireless controller circuits, amplifiers, and other circuitry of the wireless interface adapter, such as one or more antenna ports used for wireless communications via multiple radio access technologies. Each radio frequency subsystem 234 may communicate with one or more wireless technology protocols. The radio frequency subsystem 234 may contain individual subscriber identity module (SIM) profiles for each technology service provider and their available protocols for any operating subscriber-based radio access technologies such as cellular LTE communications.

In some embodiments of the present disclosure, the wireless interface adapter 230 may operate two or more wireless links. In a further embodiment, the wireless interface adapter 230 may operate the two or more wireless links with a single, shared communication frequency band such as with the 5G standard relating to unlicensed wireless spectrum for small cell 5G operation or for unlicensed Wi-Fi WLAN operation in an example embodiment. For example, a 2.4 GHz/2.5 GHz or 5 GHz wireless communication frequency bands may be apportioned under the 5G standards for communication on either small cell WWAN wireless link operation or Wi-Fi WLAN operation. In some embodiments, the shared, wireless communication band may be transmitted through one or a plurality of antennas or antennas may be capable of operating at a variety of frequency bands.

The wireless interface adapter 230 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, or similar wireless standards may be used. Wireless interface adapter 230 may connect to any combination of macro-cellular wireless connections including 2G, 2.5G, 3G, 4G, 5G or the like from one or more service providers. Utilization of radiofrequency communication bands according to several example embodiments of the present disclosure may include bands used with the WLAN standards and WWAN carriers which may operate in both licensed and unlicensed spectrums. For example, both WLAN and WWAN may use the Unlicensed National Information Infrastructure (U-NII) band which typically operates in the ~5MHz frequency band such as 802.11 a/h/j/n/ac/ax (e.g., center frequencies between 5.170-7.125 GHz). WLAN, for example, may operate at a 2.4 GHz band, 5GHz band, and/or a 6 GHz band according to, for example, Wi-Fi, Wi-Fi 6, or Wi-Fi 6E standards. WWAN may operate in a number of bands, some of which are proprietary but may include a wireless communication frequency band. For example, low-band 5G may operate at frequencies similar to 4G standards at 600-850 MHz. Mid-band 5G may operate at frequencies between 2.5 and 3.7 GHz. Additionally, high-band 5G frequencies may operate at 25 to 39 GHz and even higher. In additional examples, WWAN carrier licensed bands may operate at the new radio frequency range 2 (NRFR1), NFRF2, bands, and other known bands. Each of these frequencies used to communicate over the network 254 may be based on the radio access network (RAN) standards that implement, for example, eNodeB or gNodeB hardware connected to mobile phone networks (e.g., cellular networks) used to communicate with the information handling system 200. In the example embodiment, mobile device 200 may also include both unlicensed wireless RF communication capabilities as well as licensed wireless RF communication capabilities. For example, licensed wireless RF communication capabilities may be available via a subscriber carrier wireless service operating the cellular networks. With the licensed wireless RF communication capability, a WWAN RF front end of the information handling system 200 may operate on a licensed WWAN wireless radio with authorization for subscriber access to a wireless service provider on a carrier licensed frequency band.

The wireless interface adapter 230 can represent an add-in card, wireless network interface module that is integrated with a main board of the information handling system or integrated with another wireless network interface capability, or any combination thereof. In an embodiment the wireless interface adapter 230 may include one or more radio frequency subsystems 230 including transmitters and wireless controllers for connecting via a multitude of wireless links. In an example embodiment, an information handling system may have an antenna system transmitter for 5G small cell WWAN, Wi-Fi WLAN or WiGig connectivity and one or more additional antenna system transmitters for macro-cellular communication. The radio frequency subsystems 230 include wireless controllers to manage authentication, connectivity, communications, power levels for transmission, buffering, error correction, baseband processing, and other functions of the wireless interface adapter 230.

The information handling system 200 may further include a power management unit (PMU) 250 (a.k.a. a power supply unit (PSU)). The PMU 250 may manage the power provided to the components of the information handling system 200, e.g., the CPU 204, the GPU 206, the NPU 208, the main memory 210, the static memory 212, the drive unit 214, the output device 220, the input device 222, the wireless interface adapter 230, any combination thereof, and any other components that may require power when a power button on the information handling system 200 is actuated by a user. In an embodiment, the PMU 250 may monitor power levels and be electrically coupled to the information handling system 200 to provide this power and coupled to bus 208 to provide or receive data or instructions. The PMU 250 may regulate power from a power source such as a battery 252 or A/C power adapter 254. In an embodiment, the battery 252 may be charged via the A/C power adapter 254 and provide power to the components of the information handling system 200 when A/C power from the A/C power adapter 254 is removed.

FIG. 2 further indicates that the information handling system 200 includes an operating system (OS) 260, a basic input/output system (BIOS) firmware/software 262, one or more application programs, or a combination thereof that may be part of the computer executable code 218 that is executed at the CPU 204, the GPU 206, the NPU 208, or a combination thereof, and stored the main memory 210, the static memory 212, the computer readable medium 216 of the drive unit 214, or any combination thereof. The BIOS firmware/software 262 functions to initialize information handling system 200 on power up, to launch the OS 260, and to manage input and output interactions between the OS 260 and the other elements of information handling system 200. In a particular embodiment, BIOS firmware/software 262 resides in the main memory 208 or the static memory 212, and includes machine-executable code that is executed by the CPU 204 to perform various functions of information handling system 200 as described herein. In another embodiment (not illustrated), application programs and BIOS firmware/software 262 can reside in another storage medium of information handling system 200. For example, application programs and BIOS firmware/software 262 can reside in the drive unit 214, in a ROM (not illustrated) associated with information handling system 200, in an option-ROM (not illustrated) associated with various devices of information handling system 200, in a storage system (not illustrated) associated with network channel of the wireless interface adapter 230, in another storage medium of information handling system 200, or a combination thereof. It is to be understood that computer executable code 218 for application programs and BIOS firmware/software 238 can each be implemented as single programs, or as separate programs carrying out the various features as described herein. The information handling system 200 may also include a USB connector 270 coupled to the bus 202.

As stated above, the information handling system 200 may connect to the external wireless network 232. In particular, the wireless network 232 may have a wireless mesh architecture in accordance with mesh networks described by the wireless data communications standards or similar standards in some embodiments but not necessarily in all embodiments. The wireless interface adapter 230 may connect to the external wireless network 233 via a WPAN, WLAN, WWAN or similar wireless switched Ethernet connection in some embodiments. The wireless data communication standards set forth protocols for communications and routing via access points, as well as protocols for a variety of other operations. Other operations may include handoff of client devices moving between nodes, self-organizing of routing operations, or self-healing architectures in case of interruption.

In some embodiments, software, firmware, dedicated hardware implementations such as application specific integrated circuits, programmable logic arrays and other hardware information handling systems can be constructed to implement one or more of the methods described herein. Applications that may include the apparatus and systems of various embodiments can broadly include a variety of electronic and computer systems. One or more embodiments described herein may implement functions using two or more specific interconnected hardware modules or information handling systems with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a controller or a processor system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 216 that includes computer executable code 218 (e.g., instructions, parameters, and profiles), or receives and executes computer executable code 218 (e.g., instructions, parameters, and profiles) responsive to a propagated signal; so that a device connected to the wireless network 232 can communicate voice, video or data over the wireless network 232. Further, the computer executable code 218 may be transmitted or received over the wireless network 232 via the network interface device, i.e., the wireless interface adapter 230.

The wireless interface adapter 230 represents a network interface card (NIC) disposed within information handling system 200, on a main circuit board of the information handling system 200, integrated onto another component such as the CPU 204, in another suitable location, or a combination thereof. The wireless interface adapter 230 can include another information handling system, a data storage system, another network, a grid management system, another suitable resource, or a combination thereof. In an embodiment, the wireless interface adapter 230 may operably connect to the network 232. The connection to network 232 may be wired or wireless.

The network interface device shown as wireless interface adapter 230 can provide connectivity to the network 232, such as a wide area network (WAN), a local area network (LAN), wireless local area network (WLAN), a wireless personal area network (WPAN), a wireless wide area network (WWAN), or another network. Connectivity may be via wired or wireless connection. The wireless interface adapter 230 may include an adaptive massive MIMO Multiplexer with transmitter/receiver circuitry, wireless controller circuitry, amplifiers and other circuitry for wireless communications. The wireless interface adapter 230 may also include antenna systems 236 as described above which may be tunable antenna systems for use with the system and methods disclosed in the embodiments herein. The antenna controller 240 may also include wireless controllers to manage authentication, connectivity, communications, power levels for transmission, buffering, error correction, baseband processing, and other functions of the wireless interface adapter 230.

The information handling system 200 can include a set of computer executable code 218 that can be executed to cause the information handling system 200 to perform any one or more of the methods or computer-based functions disclosed herein. For example, computer executable code 218 may execute various software applications, software agents, or other aspects or components. Various software modules comprising application computer executable code 218 may be coordinated by the OS 260, and/or via an application programming interface (API). An example operating system may include Windows ®, Android ®, and other OS types known in the art. Example APIs may include Win 32, Core Java API, or Android APIs.

The drive unit 214 may include a computer-readable medium 216 in which one or more sets of computer executable code 218 such as software can be embedded to be executed by the CPU 204, the GPU 206, the NPU 208, or a combination thereof, to perform the processes described herein. Similarly, main memory 204 and static memory 206 may also contain a computer-readable medium for storage of one or more sets computer executable code 218 (e.g., instructions, parameters, or profiles). The drive unit 214 or static memory 212 also contain space for data storage. Further, the computer executable code 218 may embody one or more of the methods or logic as described herein. In a particular embodiment, the computer executable code 218 may reside completely, or at least partially, within the main memory 204, the static memory 206, and/or within the disk drive 216 during execution by the CPU 204 of the information handling system 200. The CPU 204, the GPU 206, and the NPU 208 also may include computer-readable media. The NPU 208 may include computer executable code 218 that includes an artificial intelligence (AI) application security module.

The main memory 208, the static memory 212, or other memory of the embodiments described herein may contain computer-readable medium (not shown), such as RAM. An example of main memory 208 can include random access memory (RAM) such as static RAM (SRAM), dynamic RAM (DRAM), non-volatile RAM (NV-RAM), or the like, read only memory (ROM), another type of memory, or a combination thereof. The static memory 212 may contain computer-readable medium (not shown), such as NOR or NAND flash memory in some example embodiments. The drive unit 214 may include access to a computer-readable medium 216 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In other embodiments, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

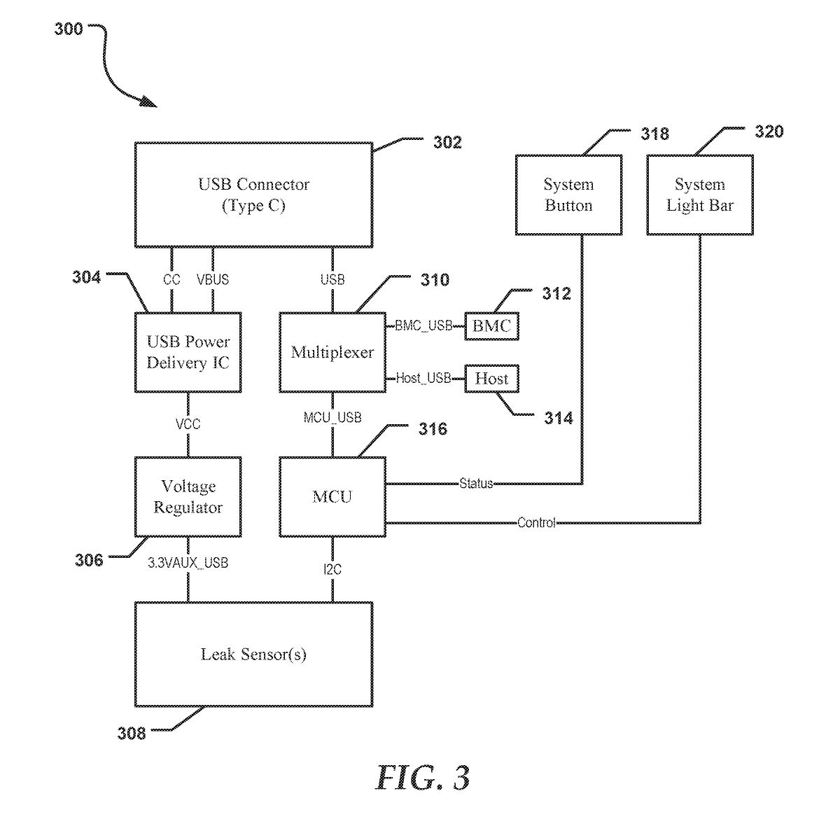

Referring now to FIG. 3, a wet/dry test circuit is illustrated and generally designated 300. The wet/dry test circuit 300 may be used to test an information handling system, e.g., any of the information handling systems described herein, for leaks prior to the initial power on of the information handling system. The wet/dry test circuit 300 includes a USB connector 302, e.g., a USB Type C connector. The USB connector 302 is coupled to a USB power deliver integrated circuit (IC) 304 that in turn, is coupled to a voltage regulator 304. The voltage regulator 304 is coupled to one or more leak sensors 308.

The wet/dry test circuit 300 further includes a multiplexer (MUX) 310 that is connected to the USB connector 302. A baseboard management controller (BMC) 312 is operably coupled to the multiplexer 310. Moreover, a host server 414 is operably coupled to the multiplexer 310. FIG. 3 further indicates that the wet/dry test circuit 300 includes a microcontroller (MCU) 312 that is coupled to the multiplexer 310 and to the one or more leak sensors 308. The microcontroller 316 may communicate with a device connected to the USB connector 302, the BMC 312, the host 314, or a combination thereof, via the multiplexer 310. A system button 318 and a system light bar 320 are operably coupled to the MCU 312. The system button 318 may be used to initiate a wet/dry test and the system light bar 320 may indicate the results of the wet/dry test.

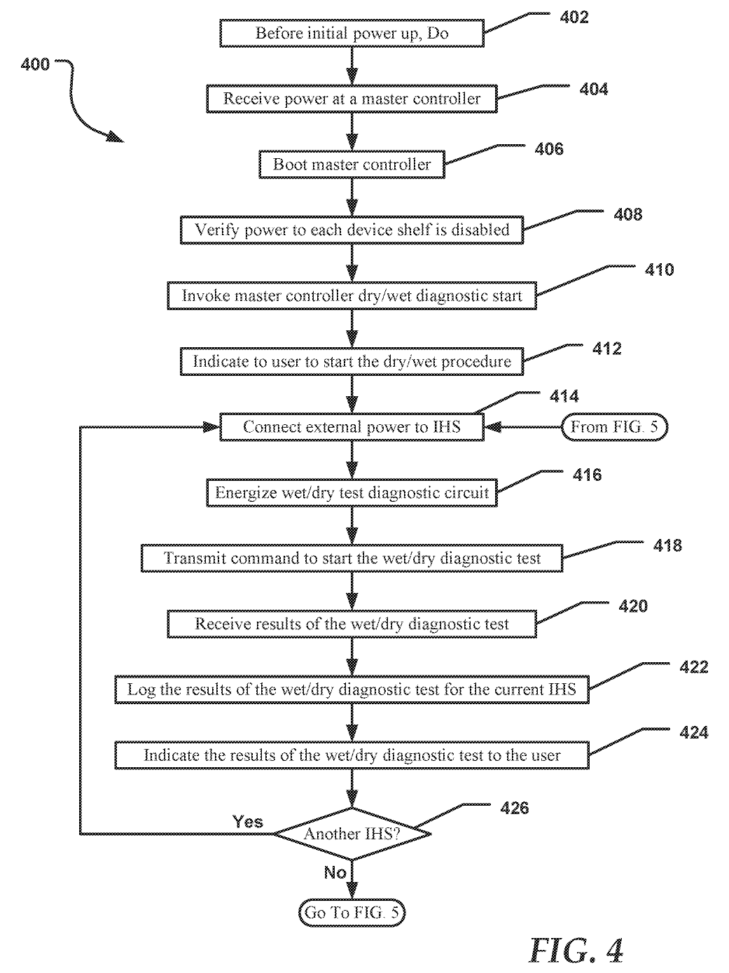

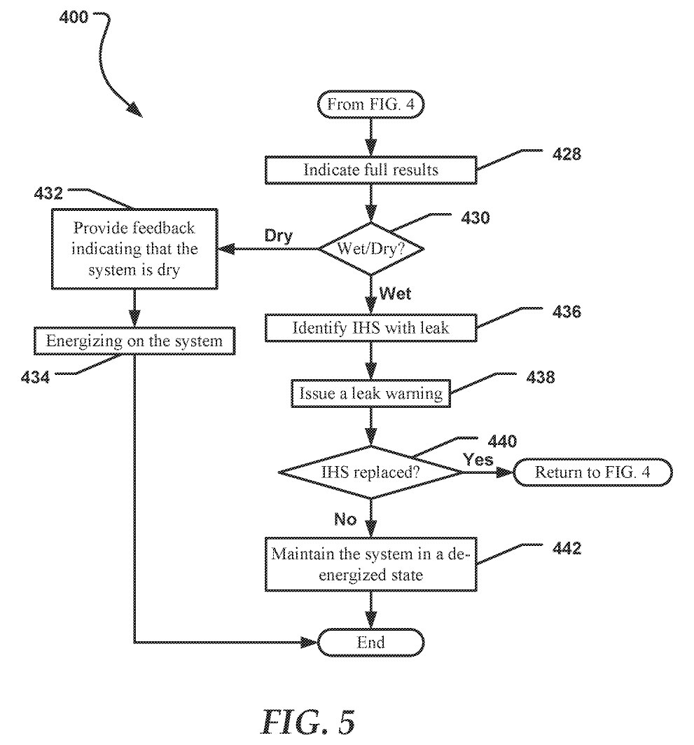

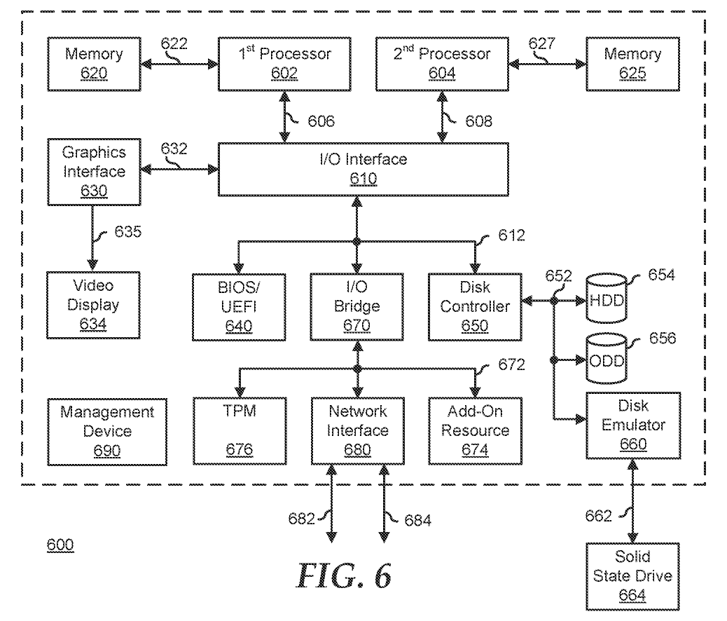

FIGS. 4 and 5 illustrate a flow diagram of a method 400 method of providing initial power to an information handling system within a cabinet or rack. The method 400 may be performed, for example, for an information handling system that is configured according to at least one embodiment of an information handling system that is described in the present disclosure and the method 400 commences at block 402. It will be readily appreciated that not every method step set forth in this flow diagram is always necessary, and that certain steps of the methods may be combined, performed simultaneously, in a different order, or perhaps omitted, without varying from the scope of the disclosure. The method steps depicted in FIGS. 4 and 5 may be executed, or employed in whole, or in part, by any of the processors disclosed herein, any other type of controller, device, module, processor, or any combination thereof, operable to employ, or otherwise execute, all, or portions of, the method 400 of FIGS. 4 and 5.

Beginning at block 402, the method 400 includes entering a do loop wherein before the initial power up of an information handling system, or multiple information handling systems, the following steps are performed. At block 404, the method 400 includes receiving power at a controller, e.g., a server controller. At block 406, the method 400 includes booting the master controller. Thereafter, at block 408, the method 400 includes ensuring power to each device shelf is disabled. This may be done by ensuring that a bus bar within the cabinet remains de-energized and is prevented from receiving power. It is to be understood that each device shelf is configured to receive an information handling system, e.g., one of the information handling systems described herein.

Moving to block 410, the method 400 may include invoking the master controller wet/dry diagnostic start. Then, at block 412, the method 400 may include indicating to a user to start the wet/dry procedure. At block 414, the method 400 may include connecting an external power source to the information handling system. For example, the external power source may be a mobile power bank that is coupled to a USB Type C connector at the information handling system. At block 416, the method 400 may include energizing a wet/dry test circuit. The wet/dry test circuit may be fully embedded within the information handling system and may include a fluid leak sensor. In another aspect, the wet/dry test circuit may be external to the information handling system, e.g., as part of an external test device, and it may connect to a leak sensor within the information handling system in order to activate the leak sensor as part of a wet/dry diagnostic test.

At block 418, the method 400 includes transmitting a command to start the wet/dry diagnostic test. For an embedded wet/dry test circuit, this command may come from an internal component, such as a baseboard management controller. Further, this command may be in response to a user pressing a button on the information handling system. For an external wet/dry test circuit, this command may come from an external microprocessor or microcontroller that is within the external test device and this command may be in response to a button press at the external test device. In other embodiments, in either case, the command may be automatically transmitted upon connection of the external power supply or the external test device.

Proceeding to block 420, the method 400 includes receiving the results of the wet/dry diagnostic test. At block 422, the method 400 includes logging the results of the wet/dry diagnostic test for the current server. Further, at block 424, the method 400 includes indicating the results of the wet/dry diagnostic test to the user. Thereafter, the method 400 proceeds to decision 426 and the method 400 includes determining if there is another information handling system that requires pre-startup leak testing. If so, the method 400 returns to block 414 and continues as described herein. Otherwise, if there is not another information handling system that requires pre-startup leak testing, the method 400 moves to block 428 of FIG. 5.

At block 428 of FIG. 5, the method 400 includes indicating the full results to the user. Then, at decision 430, the method 400 includes determining whether the system, and each information handling system within the system, is wet or dry. If the system is dry, the method 400 may proceed to block 432 and the method 400 includes providing feedback indicating that the system is dry. That feedback can be provided by illuminating an indicator light a particular color, e.g., green. At block 434, the method 400 may including energizing the system and each of the information handling systems in the system. The system may be energized by energizing a bus bar within the cabinet, or rack. Thereafter, the method 400 may end.

Returning to decision 430, if the method 400 determines that the system is wet, i.e., at least one fluid leak is detected by the leak sensor within the wet/dry diagnostic test circuit of one or more of the information handling systems, the method 400 continues to block 436 and may include identifying the information handling system with leak. If there are more than one information handling systems experiencing leaks, they will each be identified. At block 438, the method 400 may include issuing a leak warning. Thereafter, the method 400 moves to decision 440 and may include determining whether the information handling system that is identified as having a leak is replaced. In the case of multiple information handling systems with leaks, they may all be replaced. If it is determined that the information handling system, or systems, are replaced, the method 400 may return to block 414 of FIG. 4 and the method 400 may continue as described herein.

At decision 440, If the information handling system, or systems, are not replaced, the method 400 may proceed to block 442 and the method 400 may include maintaining the system in a de-energized state. In other words, none of the information handling systems in the system are allowed to power on to prevent damage to the information handling systems from leaking fluid. Thereafter, the method 400 may end.

FIG. 6 shows a generalized embodiment of an information handling system 600 according to an embodiment of the present disclosure. Information handling system 600 may be substantially similar to the information handling system 100 of FIG. 1. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 600 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 600 can include processing resources for executing machine-executable code, such as a central processing unit (CPU), a programmable logic array (PLA), an embedded device such as a System-on-a-Chip (SoC), or other control logic hardware. Information handling system 600 can also include one or more computer-readable medium for storing machine-executable code, such as software or data. Additional components of information handling system 600 can include one or more storage devices that can store machine-executable code, one or more communications ports for communicating with external devices, and various input and output (I/O) devices, such as a keyboard, a mouse, and a video display. Information handling system 600 can also include one or more buses operable to transmit information between the various hardware components.

Information handling system 600 can include devices or modules that embody one or more of the devices or modules described below and operates to perform one or more of the methods described herein. Information handling system 600 includes a processors 602 and 604, an input/output (I/O) interface 610, memories 620 and 625, a graphics interface 630, a basic input and output system/universal extensible firmware interface (BIOS/UEFI) module 640, a disk controller 650, a hard disk drive (HDD) 654, an optical disk drive (ODD) 656 , a disk emulator 660 connected to an external solid state drive (SSD) 664, an I/O bridge 670, one or more add-on resources 674, a trusted platform module (TPM) 676, a network interface 680, a management device 690, and a power supply 695. Processors 602 and 604, I/O interface 610, memory 620, graphics interface 630, BIOS/UEFI module 640, disk controller 650, HDD 654, ODD 656, disk emulator 660, SSD 664, I/O bridge 670, add-on resources 674, TPM 676, and network interface 680 operate together to provide a host environment of information handling system 600 that operates to provide the data processing functionality of the information handling system. The host environment operates to execute machine-executable code, including platform BIOS/UEFI code, device firmware, operating system code, applications, programs, and the like, to perform the data processing tasks associated with information handling system 600.

In the host environment, processor 602 is connected to I/O interface 610 via processor interface 606, and processor 604 is connected to the I/O interface via processor interface 608. Memory 620 is connected to processor 602 via a memory interface 622. Memory 625 is connected to processor 604 via a memory interface 627. Graphics interface 630 is connected to I/O interface 610 via a graphics interface 632 and provides a video display output 636 to a video display 634. In a particular embodiment, information handling system 600 includes separate memories that are dedicated to each of processors 602 and 604 via separate memory interfaces. An example of memories 620 and 625 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 640, disk controller 650, and I/O bridge 670 are connected to I/O interface 610 via an I/O channel 612. An example of I/O channel 612 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 610 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 640 includes BIOS/UEFI code operable to detect resources within information handling system 600, to provide drivers for the resources, initialize the resources, and access the resources. BIOS/UEFI module 640 includes code that operates to detect resources within information handling system 600, to provide drivers for the resources, to initialize the resources, and to access the resources.

Disk controller 650 includes a disk interface 652 that connects the disk controller to HDD 654, to ODD 656, and to disk emulator 660. An example of disk interface 652 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 660 permits SSD 664 to be connected to information handling system 600 via an external interface 662. An example of external interface 662 includes a USB interface, an IEEE 6394 (Firewire) interface, a proprietary interface, or a combination thereof. Alternatively, solid-state drive 664 can be disposed within information handling system 600.

I/O bridge 670 includes a peripheral interface 672 that connects the I/O bridge to add-on resource 674, to TPM 676, and to network interface 680. Peripheral interface 672 can be the same type of interface as I/O channel 612 or can be a different type of interface. As such, I/O bridge 670 extends the capacity of I/O channel 612 when peripheral interface 672 and the I/O channel are of the same type, and the I/O bridge translates information from a format suitable to the I/O channel to a format suitable to the peripheral channel 672 when they are of a different type. Add-on resource 674 can include a data storage system, an additional graphics interface, a network interface card (NIC), a sound/video processing card, another add-on resource, or a combination thereof. Add-on resource 674 can be on a main circuit board, on separate circuit board or add-in card disposed within information handling system 600, a device that is external to the information handling system, or a combination thereof.

Network interface 680 represents a NIC disposed within information handling system 600, on a main circuit board of the information handling system, integrated onto another component such as I/O interface 610, in another suitable location, or a combination thereof. Network interface device 680 includes network channels 682 and 684 that provide interfaces to devices that are external to information handling system 600. In a particular embodiment, network channels 682 and 684 are of a different type than peripheral channel 672 and network interface 680 translates information from a format suitable to the peripheral channel to a format suitable to external devices. An example of network channels 682 and 684 includes InfiniBand channels, Fibre Channel channels, Gigabit Ethernet channels, proprietary channel architectures, or a combination thereof. Network channels 682 and 684 can be connected to external network resources (not illustrated). The network resource can include another information handling system, a data storage system, another network, a grid management system, another suitable resource, or a combination thereof.

Management device 690 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 600. In particular, management device 690 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 600, such as system cooling fans and power supplies. Management device 690 can include a network connection to an external management system, and the management device can communicate with the management system to report status information for information handling system 600, to receive BIOS/UEFI or system firmware updates, or to perform other task for managing and controlling the operation of information handling system 600.

Management device 690 can operate off of a separate power plane from the components of the host environment so that the management device receives power to manage information handling system 600 when the information handling system is otherwise shut down. An example of management device 690 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 690 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system, comprising:
a cooling plate; and
a wet/dry leak diagnostic circuit including a leak sensor adjacent the cooling plate and a microprocessor operably coupled to the leak sensor, the microprocessor to:
detect when power is supplied to the leak sensor;
initiate a wet/dry diagnostic test; and
selectively provide initial power to the information handling system based on a result of the wet/dry diagnostic test.

1. The information handling system of claim 1, wherein when the wet/dry diagnostic test indicates that no leak is detected by the leak sensor, initial power is provided to the information handling system.

2. The information handling system of claim 1, wherein when the wet/dry diagnostic test indicates that a leak is detected by the leak sensor, initial power is not provided to the information handling system.

3. The information handling system of claim 1, wherein the wet/dry leak diagnostic circuit includes a system button and the wet/dry diagnostic test is initiated upon a user pressing the system button.

4. The information handling system of claim 1, wherein the wet/dry leak diagnostic circuit includes a system light bar that indicates the result of the wet/dry diagnostic test.

5. The information handling system of claim 1, wherein the wet/dry leak diagnostic circuit is fully embedded within the information handling system.

6. The information handling system of claim 1, the wet/dry leak diagnostic circuit is isolated from other circuitry within the information handling system.

7. The information handling system of claim 7, wherein power is supplied to the wet/dry leak diagnostic circuit via an external power source removably engaged with the information handling system.

8. The information handling system of claim 8, wherein power is supplied to the wet/dry leak diagnostic circuit via an internal power source.

10. A method of providing initial power to an information handling system, the method including:
verifying power to the information handling system is disabled;
detecting when power is supplied to an internal leak sensor;
initiating a wet/dry diagnostic test; and
selectively providing initial power to the information handling system based on a result of the wet/dry diagnostic test.

9. The method of claim 10, further comprising:
providing initial power to the information handling system when the wet/dry diagnostic test indicates no fluid leaks detected by the internal leak sensor.

10. The method of claim 11, further comprising:
maintaining the information handling system in a de-energized state when the wet/dry diagnostic test indicates a fluid leak detected by the internal leak sensor.

11. The method of claim 12, wherein power is supplied via an external power source.

12. The method of claim 13, wherein the wet/dry diagnostic test is initiated by a user pressing a button at the information handling system.

13. The method of claim 14, wherein in power is supplied via an external test device and wherein the wet/dry diagnostic test is iniated automatically when the external test device is operably coupled to the information handling system.

14. A system, comprising:
a cabinet having a power bus and a plurality of device shelves;
a plurality of information handling systems, each of the plurality of information handling systems disposed in a respective device shelf and each of the plurality of information handling systems including a processor and a cooling plate adjacent the processor; and
a master controller operably coupled to the plurality of information handling systems, the master controller including a processor to:
disable the power bus; and
determine whether any of the plurality of information handling systems is
experience a fluid leak prior to supplying initial power to the plurality of information handling systems.

15. The system of claim 16, the processor further to:
energize a wet/dry test diagnostic circuit within each of the plurality of information handling systems.

18. The system of claim 17, the processor further to:
transmit a command to start a wet/dry diagnostic test to each of the information handling
systems.

16. The system of claim 18, the processor further to:
receive a result of the wet/dry diagnostic test from the wet/dry test diagnostic circuit within each of the information handling systems.

17. The system of claim 19, the processor further to:
energize the power bus to supply power to the information handling systems, when all
wet/dry diagnostic tests indicate no fluid leaks; and
maintain the power bus in a de-energized state when any wet/dry diagnostic test indicate
a presence of a fluid leak within any of the plurality of information handling
20systems.
